(19) United States
(12) Patent Application Publication
(10) Pub. No.: US 2011/0087991 A1
(43) Pub. Date: Apr. 14, 2011

(54) Methods and Apparatus for Reliable Entry and Enhanced Presentation of IPv6 Addresses

(75) Inventors: Jerri Levison, Colorado Springs, CO (US); Thomas Morin, Colorado Springs, CO (US); Kevin Kayes, Colorado Springs, CO (US)

(73) Assignee: FLUKE CORPORATION, Everett, WA (US)

(21) Appl. No.: 12/577,944

(22) Filed: Oct. 13, 2009

(51) Int. Cl. G06F 15/177; G06F 3/048

(52) U.S. Cl. 715/780; 709/221; 715/843

(57) ABSTRACT

A technique for establishing an IPv6 address for a network device involves displaying a prefix field for accessing a list of IPv6 address prefixes, an interface identifier field for accessing a list of interface identifiers, and a fillable address field for entering an IPv6 address. An IPv6 address is constructed in the address field from an IPv6 address prefix selected from the prefix field and an interface identifier selected from the interface identifier field. The IPv6 address can be modified by manually entering characters via a user interface. A technique for displaying IPv6 addresses involves combining a mnemonic, which replaces the digits of the IPv6 address prefix portion of the address, together with the digits of the interface identifier of the IPv6 address. IPv6 addresses not associated with a mnemonic are readily identifiable.

### BACKGROUND

IPv4 is the Internet Layer protocol currently in widespread use for packet-switched networks. IPv4 addresses are 32 bits in length and can be represented by a relatively short dotted-decimal address (e.g., 192.168.0.1). IPv6 is the next generation Internet Layer protocol and includes a number of enhancements over IPv4, including a much larger address space. However, IPv6 addresses are 128 bits long (up to 39 characters), and more difficult to configure and view in comparison to IPv4 addresses.

IPv6 addresses have two main parts: a prefix that specifies the network; and an interface identifier that specifies a particular device on that network. The prefix occupies the left half of the address (the higher order digits), and the interface ID occupies the right half of the address (the lower order digits). Due to the length and complexity associated with IPv6 addresses, it is much more likely that an IPv6 address will be incorrectly configured for a network and/or device due to data entry errors, and it is more difficult to identify networks and devices by visual inspection of IPv6 addresses. Accordingly, it would be desirable to simplify entry and assignment of IPv6 addresses when configuring network devices and to enhance presentation of IPv6 addresses to ease visual inspection in order to minimize errors in configuring, deploying, and troubleshooting networks.

### SUMMARY

A technique for establishing an IPv6 address for a network device involves initially storing a list of IPv6 address prefixes that respectively specify a plurality of networks and storing a list of interface identifiers that specify devices on at least one network. A display device is configured to display a prefix field for accessing the list of IPv6 address prefixes, an interface identifier field for accessing the list of interface identifiers, and a fellable address field for entering an IPv6 address. An IPv6 address prefix is displayed in the address field in response to a user selecting an IPv6 prefix from the prefix field (e.g., via a drop down list). An interface identifier is displayed in the address field along with the IPv6 address prefix in response to selection of an interface identifier from the interface identifier field (e.g., via another drop down list). The list of interface identifiers accessible from the interface identifier field can be limited to the interface identifiers of devices of the network specified by the selected IPv6 address prefix. The IPv6 address initially constructed in the address field in this manner can be modified by entering and deleting characters via a user interface. For example, a new interface identifier can be formed by initially copying an old interface identifier from the list and then modifying one or more digits via a keypad before assigning and storing the modified address. According to another option, only the IPv6 address prefix (or only the interface identifier) is placed in the address field via selection from a list, and the digits of the remain portion of the IPv6 can be entered manually from the keypad.

A technique for displaying IPv6 addresses that have been assigned to network devices involves assigning mnemonics to the IPv6 address prefix portion of IPv6 addresses. As previously noted, the IPv6 address prefix specifies the network to which a device belongs. Accordingly, the mnemonic associated with a particular IPv6 address prefix can be designed to provide a more easily recognizable indicator of that network (e.g., its location, function, or type). When later displaying the IPv6 addresses, the address is displayed as a combination of the mnemonic (which replaces the digits of the IPv6 address prefix) and the digits of the interface identifier (i.e., appended onto the mnemonic in an unaltered form). IPv6 addresses whose address prefixes are not associated with a mnemonic can be displayed in an unaltered manner (i.e., with the digits of both the address prefix and the interface identifier). Often, this will indicate that the address prefix is mis-configured, because the prefix does not correspond to any known network. When viewing a list of IPv6 addresses, the mnemonics allow the user to quickly see which devices belong to which networks, and absence of a mnemonic for any of the listed IPv6 addresses allows the user to quickly identify which devices have mis-configured IPv6 addresses.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

FIG. 1 is a block diagram of a network environment including a plurality of local networks having a plurality of devices to which IPv6 addresses can be assigned.

FIG. 2 is a block diagram of a network-connected device configured to generate and present IPv6 addresses.

FIG. 3 is a screen shot of a display window having a prefix field, an interface identifier field, a fillable address field, and a keypad for generating an IPv6 address.

FIG. 4 is a functional flow diagram of operations performed to establish an IPv6 address for a network device.

FIG. 5 is a functional flow diagram of operations performed to present an IPv6 address for a network device using a combination of a mnemonic for the IPv6 address prefix and the digits of the interface identifier.

FIG. 6 is a table for storing a list of IPv6 address prefixes and corresponding mnemonics.

FIG. 7 is a table showing a display list of IPv6 addresses without use of mnemonics for the IPv6 address prefixes and a corresponding display list employing mnemonics within the IPv6 addresses whose IPv6 address prefixes have corresponding mnemonics.

### DETAILED DESCRIPTION

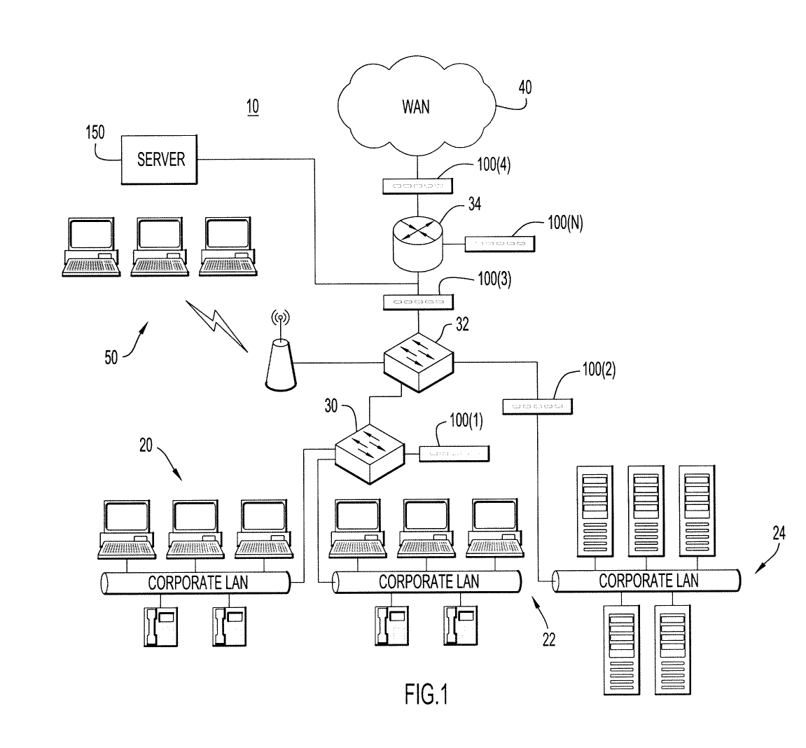

The following detailed explanations of FIGS. 1-7 reveal the methods and apparatus of the present invention. The techniques relating to generation and presentation of IPv6 addresses described herein can be employed in a network environment such as that illustrated conceptually in FIG. 1. The example network environment 10 shown in FIG. 1 comprises a plurality of interconnected local area networks (LANs) 20, 22, and 24. Each of the LANs includes a number of network devices that are assigned IPv6 addresses and that are capable of communicating with other devices within network environment 10 using their IPv6 addresses to route data. Routers 30 and 32 interconnect LANs 20, 22, and 24, and a customer edge router (CER) 34 connects the various LANs to wide area network (WAN) shown by the cloud at reference numeral 40. A wireless LAN 50 is also connected to router 32 via a wireless link. In the case where devices in the network are assigned IPv6 addresses, the different LANs may be specified by different IPv6 address prefixes, for example, in order to designate different networks.

A plurality of network monitoring devices (NMDs) 100(1)-100(N) are connected at a variety of points in the network environment 10. For example, NMD 100(1) is connected to router 30, NMD 100(2) is connected in-line between LAN 24 and router 32, NMD 100(3) is connected in-line between router 32 and CER 34, NMD 100(4) is connected in-line between the CER 34 and the WAN 40, and so on. Each NMD 100(1) to 100(N) is capable of monitoring and analyzing packets, such as Internet Protocol (IP) packets traveling in the network environment 10. The NMDs 100(1) to 100(N) capture the packets and extract certain information from the packets, such as header information or more in depth information from the packet. This extracted information is then coupled to a server 150 that communicates with the NMDs. Server 150 performs analysis on the extracted information under control of one or more software programs stored on the server. FIG. 1 is intended to illustrate conceptually a number of types of network devices, connections, networks, and architectures which may be found in a typical network environment. However, it will be appreciated that the invention is not limited to any particular types of network devices or network architectures.

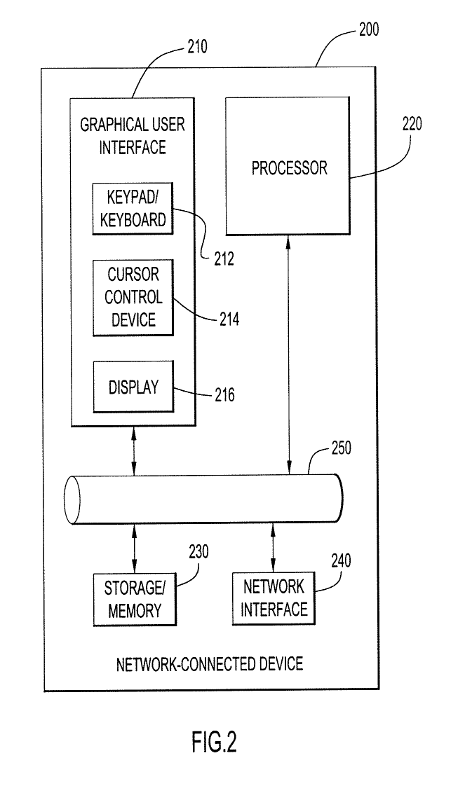

The techniques described herein for entry and presentation of IPv6 addresses can be performed by one or more network devices located at any point throughout the network environment, such as one or more of the devices shown in FIG. 1. FIG. 2 is a block diagram illustrating a network-connected device 200 configured to generate an IPv6 address based on information entered by a user and to present IPv6 addresses in a simplified manner, as described in greater detail below.

Network-connected device 200 includes a user interface, such as a graphical user interface 210 that allows a user, such as a network technician or engineer, to interact with device 200 (e.g., to enter commands, configure network equipment, and monitor network conditions and performance). User interface 210 includes a display device 216 and user input devices such as a keypad/keyboard 212 and a cursor control device 214. Display device 216 can be any of a wide variety of known devices, such as an LCD display whose optical state is transformed by controlling the color of light emitted by individual pixels based on signals from a processor. Keypad/keyboard 212 allows the user to enter alphanumeric characters, which are displayed on display device 216. Keypad/keyboard 212 can be configured as a physical device and/or as a keyboard or keypad depicted on display device 216. In the latter case, characters can be selected by moving a cursor, or by touching the screen in the case of a touch-screen display. Cursor control device 214 can be any of a variety of mechanisms that allow the user to move a cursor depicted on the display to a desired location to alter the display or to make a selection. For example, cursor control device 214 can be a mouse, a touch pad, one or more keys, a roller ball, or a touch screen (i.e., the display device itself). The graphical user interface (GUI) 210 essentially allows the user to selectively control the format and content of the display device 210 based on input from the keypad/keyboard 212 and/or cursor control device 214. In will be appreciated that GUI 210 may include other types of user-input devices such a microphone, joystick, etc.

Network connected device 200 further includes a processing capability represented in FIG. 2 by processor module 220. Processor 220 is capable of executing program instructions (i.e., software) for carrying out various operations and tasks. For example, processor 220 can interpret data and commands received from the user input devices of GUI 210, perform computations, cause information to be stored, and control the display 216 of GUI 210.

A storage capability of device 200 is represented by storage/memory module 230, which can store information relating to IPv6 addresses as well as other data or information. Storage/memory module 230 can also store program instructions (i.e., software) to be executed by processor 220 to carry out operations. Thus, the operations and methodologies described herein can be carried out by executing instructions stored on a computer readable medium (i.e., software) on a processor or processors located within the network-connected device. As used herein, the term “computer readable medium” refers to tangible media (e.g., memory or storage devices).

The interconnections between the components of network-connected device 200 are represented generally in FIG. 2 with a bus structure 250. In general, GUI 210, processor 220, and storage/memory module 230 can be interconnected in any suitable manner. A network interface 240 coupled to bus 250 provides a connection between the components of device 200 and other devices in the network environment (e.g., via an external link) and allows network-connected device 200 to send and receive information and commands to and from other devices.

The architecture depicted in FIG. 2 is conceptual and illustrates major functional units and does not necessarily illustrate physical relationships or specific physical devices within the network-connected device. The configuration and components of the network-connected device can take many forms and are described herein only in general terms for context. Those skilled in the art will appreciate that the techniques described herein for generating and presenting IPv6 addresses are applicable regardless of the particular architecture of the network-connected device.

The network environment may include a plurality of devices like that shown in FIG. 2 distributed throughout the network at multiple locations. Such devices can be located within a LAN, or coupled to or part of servers, routers, switches, network monitoring devices, etc. Further, a number of user interfaces may allow entry or access to address information at a number of locations or via a web-based interface accessible to authorized customers or service provider personnel.

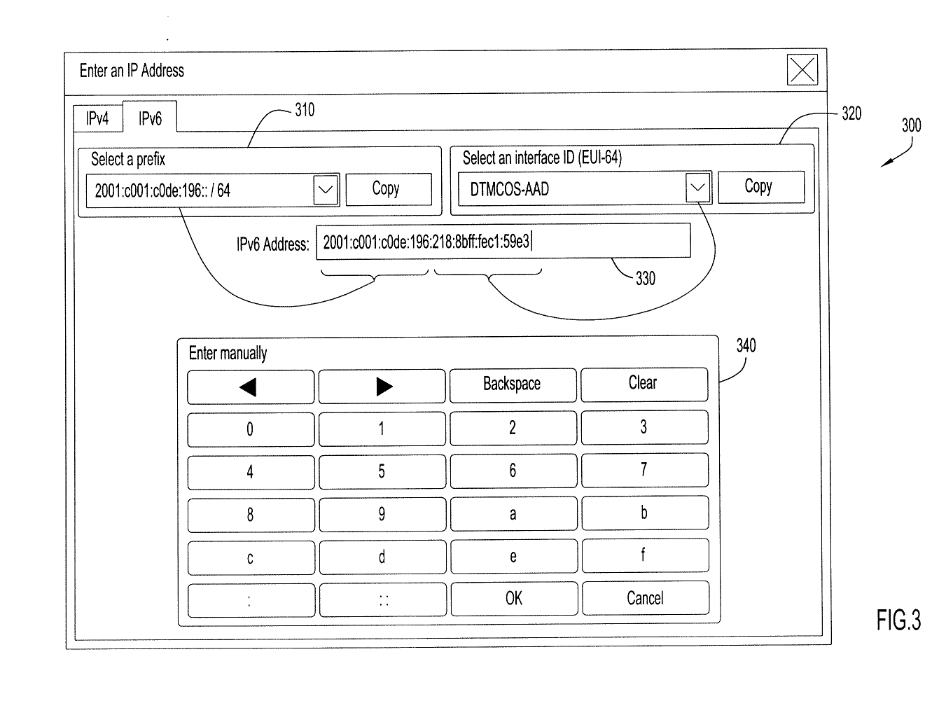

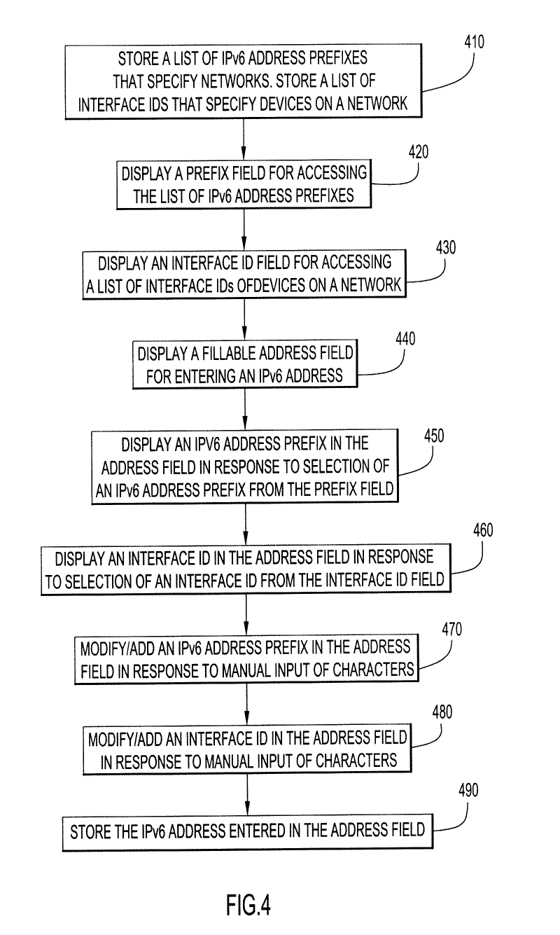

FIG. 3 shows an example of a screen shot of a display window 300 that can be displayed on a display device of a network-connected device for the purpose of generating an IPv6 address. Display window 300 includes a prefix field 310, an interface identifier field 320, a fellable address field 330, and a keypad 340 which collectively can be manipulated by a user to enter an IPv6 address. FIG. 4 is flow diagram illustrating operations performed in a network-connected device to generate an IPv6 address based on inputs from a display window such as that shown in FIG. 3.

In operation 410 shown in FIG. 4, initially, a list of IPv6 address prefixes are stored (e.g., in storage device 230) that respectively specify a plurality of networks. The networks may be, for example, separate local networks located in physically different areas or at different sites (e.g., like the arrangement shown in FIG. 1) or groups of devices that respectively perform different operations or serve different purposes within an enterprise. In general, any convenient criteria can be used to define sets of devices that constitute a network associated with a particular IPv6 address prefix.

In addition to storing a list of IPv6 address prefixes, a list of interface identifiers is stored. Each interface identifier specifies a particular device; thus, the combination of an IPv6 address prefix and an interface identifier uniquely identifies a certain device within the overall network environment.

In operation 420, 430, and 440, the display device is controlled to display in window 300, respectively: prefix field 310 for accessing the stored list of IPv6 addresses; interface identifier field 320 for accessing a stored list of interface identifiers; and fillable address field 330 for entering an IPv6 address. In the example shown in FIG. 3, prefix field 310 includes a display line for displaying a single IPv6 address prefix that has been selected or that is an initial default value. The address prefix is shown in the display line as the hexadecimal digits that constitute the prefix of an actual IPv6 address. According to another option, the address prefix shown in the prefix field can be a network name or mnemonic that corresponds to the actual IPv6 address prefix.

Prefix field 310 also includes a drop down button that, when selected, displays a drop down list of IPv6 address prefixes. One of the IPv6 address prefixes can be selected from the list (e.g., by positioning the cursor over the address prefix and clicking a mouse or by touching the screen at the display position of the desired address prefix). The selected IPv6 address prefix is then displayed on the display line of prefix field 310. Prefix field 310 further includes a copy button which, when selected, causes the IPv6 address displayed in the display line of prefix field 310 to be copied and displayed in address field 330 (operation 450). As can be seen in FIG. 3, for example, the hexadecimal digits of the IPv6 address prefix “2001:c001:c0de:196:” shown in the display line of prefix field are copied into address field 330 and constitute the higher order bits of the IPv6 address being constructed.

In the example shown in FIG. 3, interface identifier field 320 includes a display line for displaying a single IPv6 interface identifier that has been selected or that is an initial default value. In this context, the interface identifier can be a device name or mnemonic associated with a device that corresponds to the interface identifier's hexadecimal representation. Interface identifier field 320 also includes a drop down button that, when selected, displays a drop down list of devices for which IPv6 interface identifiers has been stored. Upon selecting an interface identifier from the drop down list, the selected interface identifier is displayed in the display line of interface identifier field 320.

Interface identifier field 320 further includes a copy button which, when selected, causes the interface identifier displayed in the display line of interface identifier field 320 to be copied and displayed in address field 330 (operation 460 in FIG. 4). As can be seen in FIG. 3, for example, by selecting the device name “DTMCOS-AAD” from the interface identifier field 340, the corresponding hexadecimal digits “218:8bff:fec1:59e3” of the IPv6 interface identifier of the device are appended to the previously selected address prefix to produce a complete IPv6 address in address field 330 with the interface identifier digits constituting the lower order digits of the address. Of course, copying an existing IPv6 address prefix from the prefix field into the address field and copying an existing interface identifier from the interface identifier field into the address field will produce the IPv6 address of an existing device. In the case where a user is attempting to enter a new IPv6 address which is to be associated with a device, it is necessary to modify at least one of the digits of the initial IPv6 address generated by these copying operations. Referring again to FIG. 4, in operation 470, the IPv6 address prefix in the address field can be modified in response to manual input of digits. For example, the user can place the cursor at a location within the address prefix, and then enter and delete characters as necessary using keyboard 340. This operation can be performed before or after copying an interface identifier into the address field (or in the absence of copying an interface identifier into the address field). The address prefix would typically be modified to specify a network that was not represented in the drop-down list of address prefixes presented in the prefix field. This might occur when the device whose IPv6 address is being constructed belongs to a network that is not in the database of networks available for presentation (e.g., a new network or a network not previously known to the device controlling the display).

More commonly, a new device may be added to an existing network. In this case, it may be convenient to copy the address prefix of the network into the address field and copy the interface identifier of an existing device in that network into the address field to generate a starting IPv6 address as described above. The new IPv6 address is then created by modifying one or more digits of the interface identifier in response to manual input from a user (operation 480 in FIG. 4). For example, the user can place the cursor at a location within the interface identifier in the address field, and then enter and delete characters as necessary using keyboard 340. In this manner a new IPv6 address can be generated by modifying only one or a few digits of an existing IPv6 address of another device, thereby greatly reducing the likelihood of data entry errors. In particular, where an IPv6 address is being assigned to a device on an existing network, there is very little chance that the network will be identified incorrectly, since there is no need to enter digits of the prefix portion of the address.

According to another option (indicated by the word “add” in operation 480), only the address prefix is copied into the address field from the prefix field without also copying an existing interface identifier into the address field. In this case, the interface identifier portion of the IPv6 address can be added to the address prefix in the address field in response to manually entering all of the digits of the interface identifier via the keyboard. This may be more convenient when the interface identifier of the new address is not similar to any existing interface identifier on the network or where this is the first device receiving an IPv6 address on a particular network. Although a less common scenario, the system can also be configured to permit copying of an interface identifier into the address field and then manually entering the entire address prefix.

While the example shown in FIG. 3 employs a keypad displayed on the display device for modifying digits of the IPv6 address in the address field, it will be appreciated that other user input mechanisms can be used (e.g., a physical keypad or keyboard).

Once the IPv6 address has been constructed in the address field in the manner described above, the IPv6 address can be stored (operation 490) and thereafter identifies the device to which it has been assigned, such that the IPv6 address can be used to route messages between that device and other devices within the network environment.

According to another aspect of the invention, the ease of visual inspection is improved for IPv6 addresses that are displayed in any of a variety of contexts, such as when IPv6 addresses are displayed in the course of configuring, monitoring, or maintaining a network environment. In particular, the described scheme takes advantage of the fact that the IPv6 address prefixes specify identifiable networks within the network environment. Enterprises tend to partition their network environments into portions (networks) that are meaningful to the enterprise in some manner such as location (e.g., east coast, west coast; building A, building B; first floor, second floor, etc.) or function (e.g., sales, marketing, engineering, etc.). By substituting mnemonics for the prefix portion of IPv6 addresses within a display, the displayed hybrid IPv6 addresses essentially contain built-in labels that provide a visually meaningful indication to the user about the network or group to which each device belongs. In this manner, the user can easily identify a device's location, function, or grouping in any context within which the IPv6 addresses of devices are displayed.

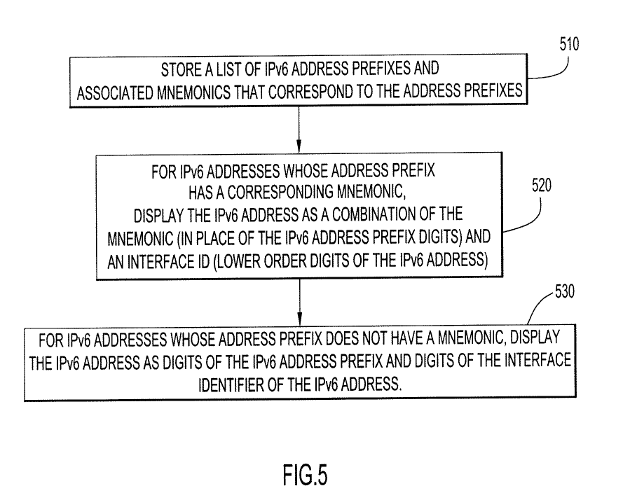

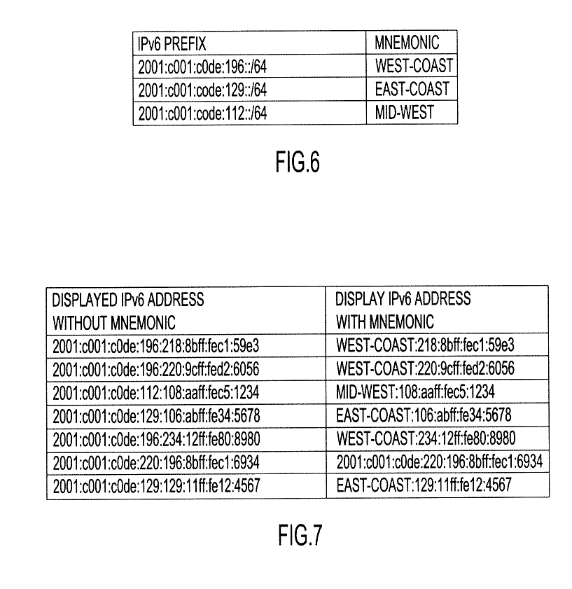

FIG. 5 is a functional flow diagram of operations performed in one or more network-connected devices to present an IPv6 address for a network device using a combination of a mnemonic for the IPv6 address prefix, which specifies a network, and the digits of the interface identifier, which specify a particular device. In operation 520, a list of IPv6 address prefixes and associated mnemonics that correspond to the address prefixes are stored in a storage device such as storage device 230 in FIG. 2 (e.g., in a table or the like). The mnemonics can be entered by a user via a suitable data entry display screen (e.g., using GUI 210 shown in FIG. 2). FIG. 6 illustrates an example of a stored table with a list of IPv6 address prefixes and corresponding mnemonics. Each IPv6 address prefix corresponds to a network defined within the network environment. In the example in FIG. 6, the network environment includes networks located on the west coast, the east coast, and the mid-west. Accordingly, the mnemonics “WEST-COAST,” “EAST-COAST,” and “MID-WEST” are associated with the respective IPv6 address prefixes of these networks in the table.

In operation 520, for IPv6 addresses whose address prefix is associated with a mnemonic, when the IPv6 address is to be displayed to the user on a display device, the IPv6 address is displayed as a combination of the mnemonic, substituted for the IPv6 address prefix, and the digits of an interface identifier of the IPv6 address. That is, the interface identifier digits are concatenated with the characters of the network address mnemonic to form a hybrid IPv6 address, such that the higher order digits of the IPv6 address are replaced with the mnemonic in the display, and the lower order digits remain the hexadecimal representation of the interface identifier.

If an IPv6 address to be displayed has an address prefix that is not associated with a stored mnemonic, the IPv6 is displayed in an unaltered manner, i.e., the IPv6 address is displayed as the hexadecimal digits of the IPv6 address prefix and the hexadecimal digits of the interface identifier (operation 530 in FIG. 3).

FIG. 7 is a table contrasting a list of IPv6 addresses displayed without use of mnemonics for the IPv6 address prefixes (left column) and a list of IPv6 addresses displayed with the use of mnemonics within those IPv6 addresses whose IPv6 address prefixes have corresponding mnemonics (right column). As can be seen from the list in the left column of FIG. 7, each IPv6 address is a lengthy sequence of hexadecimal digits, and it is relatively difficult to discern any meaningful information about the devices or their networks without carefully and deliberately studying the digits displayed in the list. In contrast, in the list in the right column, the substitution of mnemonics for the IPv6 address prefixes allows the network information of each device to be readily discerned from only a quick glance at the list. Moreover, the user can immediately identify any device whose address prefix (and hence network) is not associated with a mnemonic by the fact that the IPv6 address of such a device appears as the full set of digits of the IPv6 address. Note, for example, in FIG. 7 that the second-to-last address listed in the right column is visually distinctive relative to the characters of the mnemonics of the remaining addresses in the list. The absence of a corresponding mnemonic for the address prefix may indicate that the IPv6 address is configured incorrectly (e.g., due to a data entry error or due to an error in the process of automatically assigning IPv6 addresses). The use of mnemonics within the displayed IPv6 addresses allows a user to spot such an error quickly and easily and to ensure that IPv6 addresses have been properly mapped to network devices when configuring or troubleshooting the network.

Having described embodiments of methods and apparatus for reliable entry and enhanced presentation of IPv6 addresses, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

What is claimed is:

1. A method for establishing an IPv6 address for a network device, the method comprising:
storing a list of IPv6 address prefixes that respectively specifies a plurality of networks and storing a list of interface identifiers that specifies devices on at least one network;
displaying a prefix field for accessing the list of IPv6 address prefixes, an interface identifier field for accessing the list of interface identifiers, and a fellable address field for entering an IPv6 address;
displaying an IPv6 address prefix in the address field in response to selection of an IPv6 prefix from the prefix field;
displaying an interface identifier in the address field in response to at least one of: selection of an interface identifier from the interface identifier field; and entry of characters from a user interface, wherein the IPv6 address prefix and the interface identifier displayed in the address field form an IPv6 address; and
storing the IPv6 address displayed in the address field as the IPv6 address for the network device.

2. The method of claim 1, further comprising:
modifying the IPv6 address prefix displayed in the address field in response to entry of characters from a user interface.

3. The method of claim 1, further comprising:
modifying the interface identifier displayed in the address field in response to entry of characters from a user interface.

4. The method of claim 1, wherein the prefix field and interface identifier field provide access to drop down lists.

5. A computer readable medium storing instructions, that when executed by a computer, cause the computer to perform functions of:
storing a list of IPv6 address prefixes that respectively specify a plurality of networks and storing a list of interface identifiers that specify devices on at least one network;
controlling a display device to display a prefix field for accessing the list of IPv6 address prefixes, an interface identifier field for accessing the list of interface identifiers, and a fillable address field for entering an IPv6 address;
controlling the display device to display an IPv6 address prefix in the address field in response to selection of an IPv6 prefix from the prefix field;
controlling the display device to display an interface identifier in the address field in response to at least one of: selection of an interface identifier from the interface identifier field; and entry of characters from a user interface, wherein the IPv6 address prefix and the interface identifier displayed in the address field form an IPv6 address; and
storing the IPv6 address displayed in the address field as the IPv6 address for the network device.

6. The computer readable medium of claim 5, storing further instructions, that when executed by a computer, cause the computer to perform the further functions of:
modifying the interface identifier displayed in the address field in response to entry of characters from a user interface.

7. An apparatus for establishing an IPv6 address for a network device, comprising:
a storage device configured to store a list of IPv6 address prefixes that respectively specify a plurality of networks and to store a list of interface identifiers that specify devices on at least one network;
a user interface including a display device;
a processor configured to control the display device to display a prefix field for accessing the list of IPv6 address prefixes, an interface identifier field for accessing the list of interface identifiers, and a fillable address field for entering an IPv6 address, wherein:
the display device is configured to display an IPv6 address prefix in the address field in response to selection of an IPv6 prefix from the prefix field;
the display device is configured to display an interface identifier in the address field in response to at least one of: selection of an interface identifier from the interface identifier field; and entry of characters from a user interface, wherein the IPv6 address prefix and the interface identifier displayed in the address field form an IPv6 address; and
the storage device stores the IPv6 address displayed in the address field as the IPv6 address for the network device.

8. The apparatus of claim 7, wherein the display device is further configured to modify the IPv6 address prefix displayed in the address field in response to entry of characters via the user interface.

9. The apparatus of claim 7, wherein the display device is further configured to modify the interface identifier displayed in the address field in response to entry of characters via the user interface.

10. A method of presenting IPv6 addresses assigned to network devices, the method comprising:
storing a list of IPv6 address prefixes and associated mnemonics that correspond to the address prefixes;
for an IPv6 address whose address prefix is associated with a mnemonic, displaying the IPv6 address as a combination of: the mnemonic substituted for the IPv6 address prefix; and digits of an interface identifier of the IPv6 address; and
for an IPv6 address whose address prefix is not associated with a mnemonic, displaying the IPv6 address as digits of the IPv6 address prefix and digits of the interface identifier of the IPv6 address.

11. The method of claim 10, wherein the mnemonic indicates at least one of: a network location; a network function; and network type.

12. The method of claim 10, further comprising:
displaying a list of IPv6 addresses corresponding to a plurality of network devices, wherein devices whose IPv6 address prefixes have been defined are displayed in the list as the combination of the mnemonic and the digits of the interface identifier of the IPv6 address, and wherein devices whose IPv6 address prefixes have not been defined are displayed in the list as the digits of the IPv6 address prefix and the digits of the interface identifier of the IPv6 address.

13. A computer readable medium storing instructions, that when executed by a computer, cause the computer to perform functions of:
storing a list of IPv6 address prefixes and associated mnemonics that correspond to the address prefixes;
for an IPv6 address whose address prefix is associated with a mnemonic, controlling a display device to display the IPv6 address as a combination of: the mnemonic substituted for the IPv6 address prefix; and digits of an interface identifier of the IPv6 address; and
for an IPv6 address whose address prefix is not associated with a mnemonic, controlling the display device to display the IPv6 address as digits of the IPv6 address prefix and digits of the interface identifier of the IPv6 address.

14. The computer readable medium of claim 13, storing further instructions, that when executed by a computer, cause the computer to perform the further functions of:
controlling the display device to display a list of IPv6 addresses corresponding to a plurality of network devices, wherein devices whose IPv6 address prefixes have been defined are displayed in the list as the combination of the mnemonic and the digits of the interface identifier of the IPv6 address, and wherein devices whose IPv6 address prefixes have not been defined are displayed in the list as the digits of the IPv6 address prefix and the digits of the interface identifier of the IPv6 address.

15. An apparatus for presenting IPv6 addresses assigned to network devices, comprising:
a storage device configured to store a list of IPv6 address prefixes and associated mnemonics that correspond to the address prefixes;
a user interface including a display device; and
a processor configured to control the display device to display an IPv6 address as a combination of: the mnemonic substituted for the IPv6 address prefix; and digits of an interface identifier of the IPv6 address, for IPv6 addresses whose address prefix is associated with a mnemonic, wherein the processor is further configured to display an IPv6 address as digits of the IPv6 address prefix and digits of the interface identifier of the IPv6 address, for IPv6 addresses whose address prefix is not associated with a mnemonic.

16. The apparatus of claim 15, wherein the mnemonic indicates at least one of: a network location; a network function; and network type.

17. The apparatus of claim 15, wherein the display device is further configured to display a list of IPv6 addresses corresponding to a plurality of network devices, wherein devices whose IPv6 address prefixes have been defined are displayed in the list as the combination of the mnemonic and the digits of the interface identifier of the IPv6 address, and wherein devices whose IPv6 address prefixes have not been defined are displayed in the list as the digits of the IPv6 address prefix and the digits of the interface identifier of the IPv6 address.
